(19) United States
(12) Patent Application Publication
(10) Pub. No.: US 2010/0038382 A1
(43) Pub. Date: Feb. 18, 2010

(54) RECLOSABLE COSMETIC CONTAINER

(76) Inventor: Carmen KOTULLA, Stuttgart (DE)

Correspondence Address: John James McGlew;McGLEW AND TUTTLE, Scarborough Station, Searborough, NJ, 10510-9227, US

(21) Appl. No.: 12/582,238

(22) Filed: Oct. 20, 2009

Related U.S. Application Data
(63) Continuation of application No. 11/632,238, filed on Feb. 22, 2008.

(30) Foreign Application Priority Data
Jul. 16, 2004 (DE) 10 2004 034 585.6

(51) Int. Cl. B67D 7/06

(52) U.S. Cl. 222/192; 222/321.7

(57) ABSTRACT

A reclosable perfume container system (1) is provided with a perfume bottle base body (2) for holding a perfume and a closing body (3) that is located on the base body (2). The container system (1) has at least one activatable sound reproduction device (5) for reproducing sounds, spoken or sung text and/or music and has at least one activatable optical device (illumination/video device) (6) for emitting light signals. The container system (1) also has at least one sensor (7), which is configured in such a way that it activates the sound reproduction device (5) and the optical device (6), when the sensor is activated based on the bottle base body (2) or the closing body (3) being touched or when the closing body (3) is opened or closed.

### CROSS REFERENCE TO RELATED APPLICATIONS

This application is a continuation of pending U.S. application Ser. No. 11/632,238 filed Feb. 22, 2008, which is incorporated herein by reference and which is a United States National Phase Application of International Application PCT/DE2005/001260 and claims the benefit of priority under 35 U.S.C. §119 of German Patent Application DE 10 2004 034 585.6 filed Jul. 16, 2004, the entire contents of which are incorporated herein by reference.

### FIELD OF THE INVENTION

The present invention relates to a reclosable container for cosmetics, in particular a perfume bottle and/or jewelry bottle and more particularly a perfume system with perfume bottle and perfume. In addition, the present invention relates to a print medium having a cover, in particular a book with this further being part of the perfume system with the perfume bottle and the perfume.

### BACKGROUND OF THE INVENTION

Reclosable containers for jewelry and/or cosmetics, e.g., for perfumes and/or creams and/or body lotions and/or deodorants often have a complicated design that should draw attention to the individuality of the product, while also emphasizing and/or reinforcing the emotional effect intended by the respective cosmetic products. For example, concepts such as sensuality or sportiness can also be imparted to the consumer via a corresponding shape of the bottle and/or container, thereby creating a visual stimulus to purchase the item on the part of the consumer. This may mean that not only is the consumer's decision to purchase the item influenced by a single sense such as the sense of smell but also additional senses such as the sense of sight and touch may create an internal reference to the product and therefore can appeal to the consumer with multiple sensual stimuli.

Furthermore, the artistic design of the cosmetic containers provides a feature differentiating it from the competing products which is not to be underestimated from the standpoint of marketing, thereby achieving a better differentiation from one's immediate competitors and therefore a better delimitation. This delimitation is of particularly great economic importance in today's market, where there is an almost incomprehensible variety of products.

### SUMMARY OF THE INVENTION

The invention is based on the general idea of creating additional visual and acoustic stimuli in the form of an activatable lighting device and/or video device (optical device) and/or an activatable sound playback device (audio device) which make(s) the subject according to the present invention uniquely and easily differentiable from other competing products. This creates a design that induces strong emotions and can stimulate all the senses to achieve a desired mood. The product is therefore an expression of art and emotions.

According to the invention a perfume bottle base body is part of a perfume bottle container system comprising the perfume bottle base body with a perfume dispensing outlet. A closing body covers the perfume dispensing outlet, the closing body is removably connected to the base body for opening and closing the perfume dispensing outlet to provide direct access to perfume in the perfume bottle base body. The audio device is an activatable audio playback device with a data medium having sound or audio data for playback of the sound or audio data and for emitting sound, the emitted sound providing at least one of audible sounds, spoken words, sung words and music at or in the vicinity of the base body. The optical device is an activatable optical playback device with a data medium having light or video data for playback of the light or video data and emitting light based on the light or video data, the emitted light providing at least one of a light display, video display and text display at or in the vicinity of the base body. At least one switch or sensor is provided for activating the audio playback device and the optical playback device when the bottle or the closing body is touched or when the closing body is opened or closed to provide an activated state of the audio playback device and the optical playback device in which sound is emitted providing the at least one of audible sounds, spoken words, sung words and music at or in the vicinity of the base body and light is emitted providing the at least one of a light display, video display and text display at or in the vicinity of the base body.

The perfume bottle base body may comprise glass with at least some regions that are transparent or at least partially transparent. The closing body may comprise a reclosable cap or a reclosable cap with atomizer nozzle and a pump system supplying said perfume to said atomizer nozzle.

The reclosable container has the base body to hold a cosmetic substance, in particular to hold perfume and/or jewelry, and has the closing body arranged on the base body. In addition, as mentioned previously, at least one activatable sound playback device for playback of sounds, spoken/sung text and/or music and/or at least one activatable lighting device and/or video device for transmitting light and/or light signals is provided. The audio playback device and/or the lighting device and/or video device is/are activated when the container is touched and/or the closing body is opened and/or closed. A sensor and/or a switch detect(s) that the container has been touched and/or that the closing body has been opened or closed.

Due to the additional visual and acoustic stimuli which are activated when touching the container and/or when opening/closing the closing body, strong moods and emotions can be created which at the same time stimulate the senses and motivate people to express their feelings and thus give them an identity. In addition, an artistic product, in particular the perfume bottle, can be linked to the emotional world of the senses through the inventive reclosable container in an unusual manner. Through different texts and/or melodies, messages and perceptions can be conveyed to the consumer by a third party without the third party having to be present. In general, it is conceivable for a wide variety of speech recordings with short emotional sentences to be recorded; these may be intimate personal words, for example, that would be spoken to a person to whom one is very close or whom one values very highly. This text output can also be saved with music. Through the combination of visual, haptic and acoustic stimuli, a special personal reference of the consumer to the product is established, differing entirely from a reference that is characterized more by visual and/or haptic stimuli in the case of traditional products.

According to an advantageous embodiment of the present invention, the container has a pedestal, which contains a receptacle for a data medium. Such a receptacle may be, for example, a drawer or a removable cover/bottom in and/or on which the data medium is provided. The data medium itself may be, for example, a compact disc (CD), a digital video disc (DVD), a minidisc (mini-CD or DVD) or a USB stick that stores, for example, a text passage suitable for the emotional message of the cosmetic or a film clip and/or a piece of music, preferably a song and/or film clip suitable for the spoken language.

For example, a film clip and/or a piece of music which additionally emphasizes the emotional message may also be stored on the data medium. It is conceivable that a suitable emotional piece of music may be stored on the data medium to go along with a message with a declaration of love.

In another preferred embodiment, the container has a digital data memory which is designed for storing sounds, spoken/sung text and/or music. It is also conceivable that predetermined may be stored in the data memory and/or the data memory may be designed so that individual data may be stored there. In the case of predetermined data, a clear allocation of sounds and/or text and/or music to the respective product being distributed is possible and an emotional reference to the product can be established. With a data memory with which individual data may be saved, it is possible to convey individual messages and/or emotional references, e.g., a personal declaration of love spoken in one's own voice which should be aimed directly at the recipient of the container. In contrast with the predetermined data, it is possible in this way to establish an emotional reference between the recipient and the sender of the inventive container and thereby establish a special personal relationship between the two. This may be a motivating factor in expressing emotional feelings or inducing responses in the form of gratitude, amazement, advice or the like. In particular this makes it possible to save messages prepared in several languages with the particular language desired in the individual case. In the variant with a savable message, it is also conceivable for a message to be recorded directly by the consumer and then stored in the data memory. In general, the data memory may have a wireless or a wired interface by means of which the data is transferred to the data memory.

The lighting device and/or video device is expediently designed so that it creates motion pictures and/or reflections or even video clips. Motion pictures comprise, for example, variations in color and/or intensity. Video clips are include, for example, video sequences in which emotions are expressed and/or feelings can be seen or stimulated.

For example, it is also conceivable to use polished prismatic bodies which are arranged in the container or on a wall of the container, for example, thereby inducing special visual effects. For example, polished glass prisms may be used as decoration and as an artistic expression for the container and/or its cover. The movie and/or reflections increase the visual stimulus and differentiate the inventive container even more from the competing products and therefore it becomes art. In general, it is conceivable here for the lighting device and/or video device to illuminate at least portions of the surface structure of the container and/or the base and/or the closing body. Depending on the desired visual effect, different lighting may be selected, so that an additional individualization may be achieved even within a product series.

In another advantageous embodiment of the inventive approach, a light-conducting and/or luminous and/or illuminated lighting element may also be provided inside the container. Such a lighting element may be designed, for example, in the form of a cross and/or a heart and may additionally convey emotional messages between the sender and recipient of the container. It is also conceivable that a lighting element in the form of a heart, for example, might flash like a heartbeat, which should express to the recipient that the heart of the sender is beating for the recipient. In addition, a vibrating device may also be provided which causes the lighting element, preferably the heart, or the entire container to vibrate in the activated state. The vibrating device may also be activated by the sensor. In general, any type of symbols, whether religious, sensual, erotic, athletic, motivating or of another type are also conceivable. The lighting element may be illuminated and may emit lights, resulting in indirect lighting of the container from the inside, or both the lighting element and at least portions of the container may be illuminated so that additional optical effects can be achieved.

The audio playback device and the lighting device and/or video device are expediently connected to one another so that optical signals of the lighting device and/or video device are adapted to acoustic signals of the audio playback device or to vibration signals of the vibration device. The adaptation here may be similar to lighting in a discotheque to the rhythm of the acoustic signals, e.g., the music and may support it and/or provide background music. This creates a special harmony between the visual and acoustic stimuli so that an especially harmonic and uniform overall image is presented to the observer. Thus all the senses are stimulated.

In addition, in a preferred embodiment the base of the container may be provided with Chinese lacquer and/or may be made of metal or wood or plastic. In particular in the case of expensive cosmetics, stimulus to purchase may also be created by designing the packaging, i.e., in this case the container, in an especially complex and visually attractive manner. For example, it is conceivable here to use ebony wood, which gives a particularly high-quality impression because of its dark color. Painting, e.g., with Chinese lacquers and/or gold lacquers, is of course also conceivable and may in particular integrate a playful component into the design of the container and/or the base.

In an especially preferred embodiment of the inventive approach, the audio playback device and/or the lighting device and/or video device and/or vibration device are designed so that they are automatically inactivated again approximately 10 to 15 seconds after being activated. The energy source should be protected as much as possible because the audio playback device as well as the lighting device and/or video device require a power source for activation, but this is not usually replaceable or can be replaced only with great complexity, and moreover, it is fixedly connected to the product. By inactivating the audio playback device and/or the lighting device and/or video device and/or vibration device after approximately 10 to 15 seconds, i.e., after a very short period of time, it is possible to ensure that the power source can handle the power supply for the entire device as long as possible. In particular this avoids completely draining the power source after a single use, so that the optical and/or acoustic stimuli are then no longer available in the future. The capacity of the power source is preferably designed to be such that it is sufficient for the entire useful lifetime of the container for operation of the audio playback device and/or the lighting device and/or the video device.

The present invention relates to the problem of providing an improved embodiment for a print medium of the type mentioned above that will make it possible in particular to achieve additional design effects to thereby increase the attractiveness and acceptance of the container and create an additional stimulus to purchase.

It is self-evident that the features described above and those yet to be explained below may be used not only in the particular combination indicated but also in other combinations or alone without going beyond the scope of the present invention.

Preferred exemplary embodiments of the present invention are depicted in the drawings and explained in greater detail in the following description, whereby the same reference numerals are used to refer to the same or functionally identical or similar components.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a front view showing an inventive reclosable container for cosmetics as well as perfume bottle container system components,

FIG. 2a is a detailed view of a base of the container with a receptacle for a data medium;

FIG. 2b is a view similar to that in FIG. 2a but with a different receptacle;

FIG. 3 is a view showing an inventive print medium with a cover; and

FIG. 4 is a view of an artistic cabinet for presentation of the container and/or the print medium as perfume bottle container system components.

### DESCRIPTION OF THE PREFERRED EMBODIMENTS

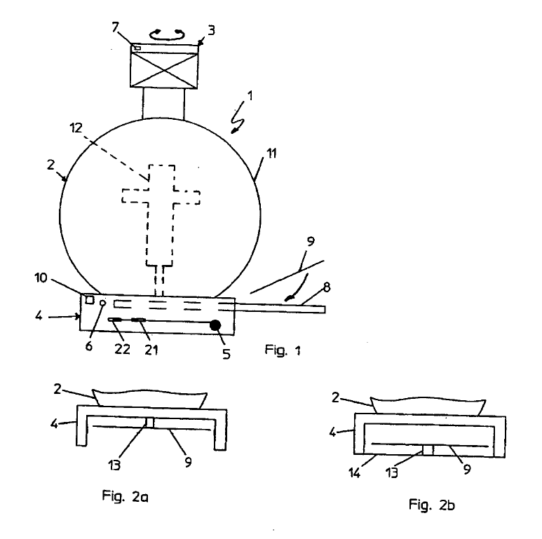

Referring to the drawings in particular, according to FIG. 1, a reclosable container system 1 has a base body 2 to hold a cosmetic substance and/or jewelry, a closing body 3 arranged on the base body 2 and a pedestal 4. According to FIG. 1, the reclosable container 1 is a perfume bottle (designed to hold perfume), but other embodiments are also conceivable, in particular for holding creams or powder. The container 1 may of course also be used to hold shower gel, body lotion or soap or it may identify an entire line of cosmetic personal care products. For example, the container 1 may be embodied as a bottle, a mirrored can, a jewelry can or a powder can. The closing body 3 arranged on the base body 2 may be released from the base body 2 and/or connected to it by a rotational movement according to FIG. 1, thus allowing access to the cosmetic substance stored in the container 1 or closing it.

The rotatable closing body 3 shown in FIG. 1 is to be seen merely as an example, so that other closing bodies 3, e.g., a closure with a pump system and an atomizer nozzle or an attachable closing body 3 are also conceivable and should also be encompassed by the present invention.

According to this invention, the container 1 has at least one activatable audio playback device 5 for playback of sounds, spoken/sung text and/or music and/or at least one activatable lighting device and/or video device 6 for emitting light and/or light signals. The audio playback device 5 as well as the lighting device and/or video device 6 are arranged in the pedestal 4 in the example illustrated in FIG. 1, but it is also conceivable for the audio playback device 5 and/or the lighting device and/or video device 6 to be arranged in or on the base body 2 and/or in or on the closing body 3. To activate the audio playback device 5 and/or the lighting device and/or video device 6, a sensor 7 or a switch in general is provided, designed so that it activates the respective device 5 and/or 6 when the container 1 is touched and/or when the closing body 3 is opened/closed.

According to FIG. 1, the switch or sensor 7 is arranged on the closing body 3, but it is also conceivable for the at least one sensor 7 to be arranged on the base body 2 or on the pedestal 4. A connection between the sensor 7 and the audio playback device 5 and/or the lighting device and/or video device 6 may be accomplished by way of very fine electric lines (not shown) and/or by a so-called conductive lacquer, especially transparent. The electric lines as well as the conductive lacquer may additionally be used as design components.

According to FIG. 1, the container 1 has the pedestal 4 which contains a receptacle 8 for a data medium 9. The receptacle 8 here is designed as a drawer. Likewise, it may be designed as a slot with a corresponding ejection mechanism. Examples of data media 9 include the fact that the data medium 9 may be a compact disc (CD) or a digital video disc (DVD) or a minidisc (mini-CD or DVD) or a USB stick. Likewise sounds, spoken/sung text and/or music may be stored on the data medium 9 and should also convey an additional message to the person purchasing the container 1. In particular, melodies or songs that are in a direct emotional relationship to spoken emotional messages and the cosmetics to be sold are conceivable here. Spoken text or music songs which convey emotions in addition to the spoken messages and/or as components of the perfume are also conceivable. The data media 9 sold with the container and the cosmetics contained therein, e.g., perfume, thus provide supplementary stimulation of multiple senses when reproduced, first of all through the scent of the perfume, but also through the music and the emotional words, i.e., messages coordinated with it. This achieves the result that feelings and several senses can be triggered stimulated simultaneously without having to confront the consumer himself. In addition, an emotional message of art, beauty and the senses may be conveyed to the person acquiring the container.

A short poem or short story which is supplied in the form of a brochure, for example, and fits at least one title of the following topics, for example, may be suitable for the spoken words and/or melodies stored on the data medium 9 and/or in the data memory 10: feelings (heart, love, passion, amazement, forgiveness), success (frame, dynamics, struggle, victory), religion (God, blessing, light, guidance), charity (poverty, need, disease, survival), lifestyle (art, fashion).

In addition, it is also fundamentally possible for a playback device for the data medium 9 to be arranged in the pedestal 4 of the container 1, making it possible to play back the information stored in the data medium 9 by way of corresponding loudspeakers, which are preferably also integrated into the pedestal. For example, the receptacle 8 itself forms a part of the playback device.

In addition to the data medium 9, the container 1 has the digital data memory 10 which is designed for storing sounds, spoken/sung test or music. The data memory 10 is preferably fixedly connected to the container 1 and/or the closing body 3 or the base 4 and is designed as a microchip 10′. Depending on the embodiment of the closing body 3 and/or the base 4, a more favorable integration of the microchip 10′ into one of the two parts may be performed. The data memory 10 and/or the microchip 10′ may be designed to be removable.

In principle, the data memory 10 may contain predetermined data which is emotionally related to the perfume stored in the container 1, for example. In general, it is also conceivable for the data memory 10 to be designed in such a way that individual data can be stored. Such individual data may include, for example, emotional messages of art and the senses and/or personal messages from the sender of the container 1 to the recipient of the container 1 such as a declaration of love. In general, the data memory 10 may have a wireless or wired interface by means of which the data is transferred to the data memory 10.

It is particularly advantageous that the messages can be recorded in different languages, so that the marketing of the product is not subject to any linguistic restrictions.

In particular it is possible to provide for the data memory 10 to be empty at first or to reserve a standard content for distribution of the containers 1. Only when the container 1 is sold does the particular customer decide which message is to be saved in which language in the data memory 10. With a corresponding writing device, the respective data memory can then be provided with the desired message in the desired form. In the case of data memory 10 installed in the container 1, this may be accomplished via a corresponding interface, but it is preferably accomplished telemetrically. With a data memory 10 that is easily removable, it is expedient to connect the data memory 10 directly to the writing device to perform the desired configuration of the data memory 10.

In the example shown in FIG. 1, the container 1 is designed to be at least partially transparent and is, for example, polished, delustered or engraved and/or has a surface structure 11. The base body 2 may essentially be made of glass or plastic or coated with a substance or provided with polished crystals.

The abovementioned lighting device and/or video device 6 in the activated state illuminates at least portions of the surface structure 11 of the container 1 and/or of the pedestal 4 and/or of the closing body 3, whereby the lighting device and/or video device 6 can in general also create a direct or indirect lighting of at least portions of the container 1 or the entire container 1. It is also conceivable here that the lighting device and/or video device 6 may be designed so that it creates motion pictures and/or reflections or even film clips. Reflections may be created for example by the surface structure 11 of the base body 2 and/or other light-conducting elements not shown here.

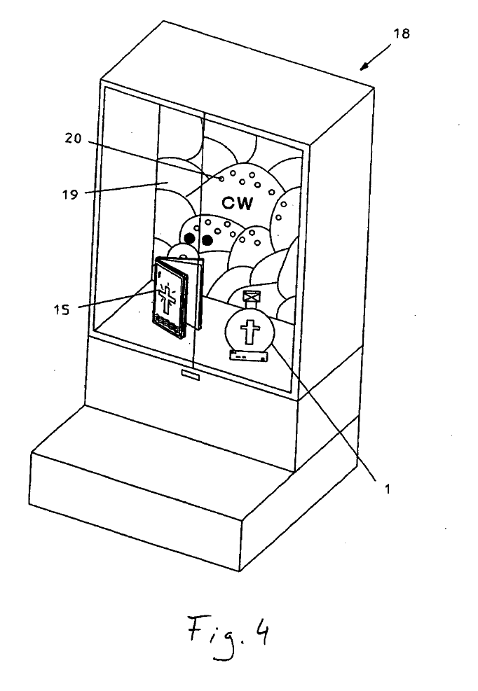

According to FIG. 1, a light-conducting and/or a luminous and/or an illuminated element 12 is provided inside the container 1 and may have a different shape, depending on the message to be conveyed. For example, lighting elements 12, which are designed as a heart (see FIG. 1) or as a cross (see FIG. 3) are conceivable. The illuminated lighting element 12 may again have an emotional reference to the cosmetic substance stored in the container 1. In general, it is conceivable here for the lighting element 12 to be connected by a fiber-optic line to the lighting device and/or video device 6 or to be illuminated indirectly by light reflected from the surface structure 11. Depending on the embodiment, it is thus possible to create different optical effects. Additionally or alternatively, a lighting element which is situated on the outside of the container 1 may also be provided. The container 1 may thus be illuminated from the inside and/or from the outside. In addition, a vibration device 21 may also be provided which causes the lighting element 12, preferably the heart or the entire container 1 to vibrate when in the activated state. The vibration device 21 may also be activated by the sensor 7, for example.

As mentioned in the introduction, both the audio playback device 5 and the lighting device and/or video device 6 may be activated by the sensor 7, whereby both devices 5 and 6 may preferably be linked together in such a way that optical signals of the lighting device and/or video device 6 are adapted to acoustic signals of the audio playback device 5 or to vibration signals of the vibration device 21. The optical signals may have, for example, the same rhythm as the acoustic signals and may thereby support, for example, music emitted by the audio playback device 5.

To protect the energy source (not shown here), which is required for operation of the audio playback device 5, the lighting device and/or video device 6 and/or the vibration device 21 and thus to maintain the acoustic and/or visual effects of the inventive container 1 for as long as possible, the audio playback device 5 and/or the lighting device and/or video device 6 may be designed so that they are deactivated again approximately 10 to 15 seconds after being activated. This prevents the energy source from being discharged too rapidly and in the optimum case ensures functioning of both the audio playback device 5 and the lighting device and/or video device 6 and the vibration device 21 over the entire period of use of the container 1, expediently as long as the perfume and/or the cosmetics have not been consumed.

In addition or as an alternative to the sensor 7 (touch sensor), for the case when the container 1 is rotatably mounted in the pedestal 4, a rotation sensor 7′ may also be provided to activate and/or deactivate the audio playback device 5 and/or the lighting device and/or video device 6 and/or the vibration device 21 when the container 1 is rotated. This creates another option for activation and/or deactivation of the aforementioned devices 5 and 6. For example, it is conceivable for the lighting device and/or video device 6 to be activated on activation of the touch sensor 7, whereas the audio playback device 5 or the vibration device 21 is activated by turning the container 1 in the pedestal 4. A rotary drive (not shown) which is activated by the sensor 7 and causes the container 1 to rotate in the pedestal 4 may of course also be provided.

Furthermore, a fog generator 22 which is activatable by the switch or sensor 7, 7′ may also be provided to generate fog at least inside the container 1 in the activated state. The fog generator 22 may also be designed so that in the activated state it generates fog only outside of the container 1 or both inside or outside the container 1. For example, an ultrasonic generator may be used as the fog generator 22. The fog can create an especially mystical scene. In general the fog generator 22 and the other devices 5, 6 and 21 may be arranged in the pedestal 4 or in the closing body 3.

Since the inventive container 1 is preferably more suitable for the higher-priced sector, it is conceivable that the pedestal 4 and/or the closing body 3 of the container 1 is provided with Chinese lacquer and/or made of metal or wood. Especially complicated working of metal surfaces and/or use of ebony wood, for example, may emphasize the exquisite positioning of the product. In addition, paintings and/or decorations, for example, of gold-colored metals, which additionally support the differentiation of the product from competing products, are also conceivable.

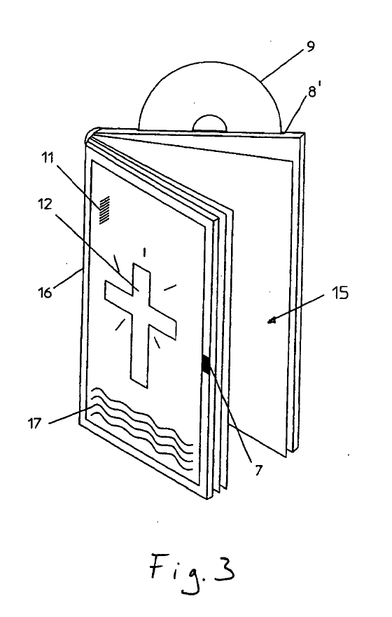

According to FIG. 2a, another variant of a receptacle 8 for the data medium 9 in the pedestal 4 is shown. The pedestal 4 here is open toward the bottom and has a holding device 13 on which the data medium 9 is secured. The variant of the pedestal 4 shown in FIG. 2b additionally has a removable bottom 14 on which a holding device 13 for holding data medium 9 is also arranged. It is of course also conceivable for the holding device 13 according to FIG. 2b to be arranged directly on the pedestal 4 and for the bottom 14 to be attached to the pedestal 4 only from beneath and thereby protect the data medium 9 from damage and/or soiling.

According to FIG. 3, a print medium 15 with a cover 16, e.g., a book, has at least one activatable audio playback device 5 (not shown) for playback of sound, spoken/sung text and/or music and/or at least one activatable lighting device and/or video device 6 for emitting light signals, e.g., a running text or a video text. In addition, at least one sensor 7 is provided on the print medium 15 and is designed so that the print medium 15 activates the audio playback device 5 and/or the lighting device and/or video device 6 when someone touches the print medium 15 and/or when the print medium 15 is opened/closed. In this way, acoustic and visual signals can be conveyed as soon as an interested person touches the print medium 15, picks it up and/or opens it. A receptacle 8′ for the data medium 9 may be provided in the cover 16 of the print medium 15. As in the case of the inventive container 1, the data medium 9 may also be a compact disc (CD) or a digital video disc (DVD) or a minidisc (mini-CD or DVD) or a USB stick.

The print medium 15 also has a digital data memory 10 which is designed for storage of sound, spoken/sung text and/or music. The data memory 10 is preferably designed as a microchip and is integrated into the cover 16 of the print medium 15. Like the data memory 10 of the container 1, this data memory in the print medium 15 may contain predetermined data or may be designed so that individual data can be stored on it.

To achieve additional visual effects, the cover 16 may be at least partially transparent and may receive direct or indirect illumination from the lighting device and/or video device 6. If the cover 16 additionally has a surface structure 11, then motion pictures and/or reflections and/or video sequences and/or films which represent a particular optical stimulus can be generated by means of the lighting device and/or video device 6.

Again in the case of print medium 15, a light-conducting and/or luminous and/or illuminated lighting element 12, here a cross, which creates a special emotional reference, and a special optical signal may also be provided within the cover 16 like the container 1. In general, lighting elements 12 having various shapes, such as a flashing heart, are conceivable. It is also conceivable here for at least the lighting element 12 to be excited by a vibration device 21.

To also be able to produce a unit of optical and acoustic signals with the print medium 15, the audio playback device 5 and the lighting device and/or video device 6 and the vibration device 21 may be linked together in such a way that the optical signals of the lighting device and/or video device 6 can be adapted to the acoustic signals of the audio playback device 5 and/or to the vibration signals of the vibration device 21. As is the case with the container 1, an optical background for the sounds reproduced by the audio playback device 5 can be achieved here.

Since print media 15 and books in particular are long-lived goods, the audio playback device 5 and/or the lighting device and/or video device 6 is/are designed so that they become inactive again approximately 10 to 15 seconds after being activated and thereby save on electric power.

As a special visual stimulus, the cover 16 may additionally or alternatively contain a free-flowing and/or pourable filling 17 which is also illuminated by the lighting device 6. The free-flowing and/or pourable filling 17 may be designed as a sand-water-gel filling, for example, which touches the emotional level of the viewer in particular and would be symbolic of feelings.

The print medium 15 may be in particular a biographical book which is designed as a combined art-culture book and thus induces a unity of art and emotion with stimulation of all senses. In this context, the combination of art and culture is especially important with both the print medium 15 and with the container 1.

To improve the marketing of the inventive container and/or the inventive print medium 15, an artistic cabinet 18 as illustrated in FIG. 4 in which the container 1 and/or the print medium 15 is/are presented to the customer may also be provided. The containers 1 and/or the print media 15 may be stored in the lower half of the artistic cabinet 18. When a customer and/or an interested party reaches into the artistic cabinet 18, a light should automatically go on and a song that suits the respective container 1 and/or the respective print medium 15 should be played automatically. In addition, a mosaic design 20 may be installed on a rear wall 19 of the artistic cabinet 18 to establish a reference to an artistic label in particular. It is possible to provide here for the mosaic 20 to be permanently illuminated or to light up automatically when a person reaches into the artistic cabinet 18.

Ultimately the artistic cabinet 18 may be provided essentially with the same furnishing features as the container 1 and/or the print medium 15. Accordingly with the help of the artistic cabinet 18 essentially the same emotional effects can be achieved as with the container 1 and the print medium 15 so that, on the whole, this forms a uniform overall concept that appeals to the respective customer emotionally in various ways.

The inventive container 1 and/or the print medium 15 increase(s) the desire of the consumer to purchase the item due to the unity of the visual and acoustic stimuli or at least make the customer curious and attentive to the product displayed therein. In particular, emotional messages can be conveyed by the acoustic and/or visual stimuli, resulting in stimulation of the senses and thereby establishing a closer emotional tie between the consumer and the product being offered. At the same time, a wide variety of different emotional messages such as love, passion and success can be conveyed via a wide variety of lighting elements 12 and/or melodies and/or spoken text.

While specific embodiments of the invention have been described in detail to illustrate the application of the principles of the invention, it will be understood that the invention may be embodied otherwise without departing from such principles.

What is claimed is:

1. A perfume bottle container system comprising:
a perfume bottle base body with a perfume dispensing outlet;
a closing body covering said perfume dispensing outlet, said closing body being removably connected to said base body for opening and closing said perfume dispensing outlet to provide direct access to perfume in said perfume bottle base body;
an activatable audio playback device with a data medium having sound or audio data for playback of said sound or audio data and for emitting sound, said emitted sound providing at least one of audible sounds, spoken words, sung words and music at or in the vicinity of said base body;
an activatable optical playback device with a data medium having light or video data for playback of said light or video data and emitting light based on said light or video data, the emitted light providing at least one of a light display, video display and text display at or in the vicinity of said base body; and
at least one switch or sensor for activating said audio playback device and said optical playback device when said bottle or said closing body is touched or when said closing body is opened or closed to provide an activated state of said audio playback device and said optical playback device in which sound is emitted providing said at least one of audible sounds, spoken words, sung words and music at or in the vicinity of said base body and light is emitted providing said at least one of a light display, video display and text display at or in the vicinity of said base body.

2. A perfume bottle container system according to claim 1, wherein the perfume bottle base body comprises glass with at least some regions that are transparent or at least partially transparent.

3. A perfume bottle container system according to claim 2, wherein said audio playback device and optical playback device are linked together in said activated state such that signal changes of optical signals of said optical playback device are synchronized with signal changes of acoustic signals of said audio playback device.

4. A perfume bottle container system according to claim 3, further comprising perfume in said base body and a pedestal that contains a receptacle or the playback device for said data medium of said audio playback device and said optical playback device, wherein:
said data medium is a compact disc or a digital video disc (DVD) or a minidisc (mini-CD or DVD) or a USB stick;
the bottle container system has a digital data memory adapted to store at least one of sound, spoken text, sung text and music; and
said base body is supported on said pedestal.

5. A perfume bottle container system according to claim 4, wherein said data memory is a microchip or wherein said data memory is integrated into said pedestal or into said closing body of said base body.

6. A perfume bottle container system according to claim 4, wherein predetermined data is stored on said data memory or wherein said data memory is adapted to store designed so that individual data may be stored.

7. A perfume bottle container system according to claim 1, wherein said base body or said closing body is polished or has a surface structure or comprises polished prismatic bodies disposed in or on said base body or in or on said closing body.

8. A perfume bottle container system according to claim 4, further comprising, within said base body or outside of said base body, a light-conducting element or an illuminating element or an illuminated lighting element, said light-conducting element or illuminating element or illuminated lighting element cooperating with said activatable optical playback device for illuminating said base body from the inside or from the outside.

9. A perfume bottle container system according to claim 3, further comprising a vibration device which causes said base body to vibrate in said activated state.

10. A perfume bottle container system according to claim 9, wherein said audio playback device and optical playback device are linked together with said vibration device in said activated state such that a period or pattern of vibration is synchronized with signal changes of acoustic signals of said audio playback device and signal changes of optical signals of said optical playback device.

11. A perfume bottle container system according to claim 1, wherein said optical playback device creates a direct or indirect lighting of at least portions of said base body or of the entire base body to provide said at least one of a light display, video display and text display at said at least portions of said base body or of the entire base body.

12. A perfume bottle container system according to claim 11, wherein said optical playback device provides at least one of motion pictures, reflections, and video clips as said at least one of a light display, video display and text display.

13. A perfume bottle container system according to claim 4, wherein optical playback device illuminates at least portions of surface structure of said base body or said pedestal or said closing body to provide said at least one of a light display, video display and text display at said at least portions of said surface structure of said base body or said pedestal or said closing body.

14. A perfume bottle container system according to claim 1, further comprising a light-conducting element or an illuminating element or an illuminated lighting element within said base body, said light-conducting element or illuminating element or illuminated lighting element cooperating with said activatable optical playback device for illuminating said base body from inside said base body.

15. A perfume bottle container system according to claim 4, further comprising a rotary drive activated by said switch or sensor for rotating said base body on said pedestal.

16. A perfume bottle container system according to claim 15, further comprising a rotation sensor or a touch sensor for activating or deactivating said audio playback device, said lighting device, said video device, or said vibration device on rotation of said base body on said pedestal.

17. A perfume bottle container system according to claim 9, wherein said audio playback device and optical playback device or said vibration device are programmed to become inactive approximately 10 to 15 seconds after being activated.

18. A perfume bottle container system according to claim 1, wherein said audio playback device emits sound from said closing body.

19. A perfume bottle container system according to claim 1, further comprising a fog generator adapted to be activated by said switch or sensor for generating a fog at least inside said base body in an activated state.

20. A perfume bottle container system according to claim 1, wherein said closing body comprises an atomizer nozzle and a pump system supplying said perfume to said atomizer nozzle.
